(19) United States
(12) Patent Application Publication
(10) Pub. No.: US 2005/0230223 A1
(43) Pub. Date: Oct. 20, 2005

(54) Pre-tensioner

(76) Inventor: Franz Gartner, Oberelsbach (DE)

Correspondence Address: BRINKS HOFER GILSON & LIONE, P.O. BOX 10395, CHICAGO, IL, 60610, US

(21) Appl. No.: 11/106,211

(22) Filed: Apr. 14, 2005

(30) Foreign Application Priority Data
Apr. 16, 2004 (DE) 10 2004 018 568.9

(51) Int. Cl. B65G 47/84

(52) U.S. Cl. 198/465.4

(57) ABSTRACT

A transporting apparatus having a fixed transporting rail and at least one transporting roller, which is supported by the transporting rail. The apparatus can be loaded with an item to be transported, preferably having an axial through passage and two disk-shaped, preferably circular flanges, which are aligned parallel to each other and are not rotated during the transportation of the transporting roller, and, between the flanges, a rotatably mounted rolling element of smaller diameter, for example in the form of a rotatably mounted sleeve, which element rolls on the transporting rail during the transportation of the transporting roller. A carry-along device is provided for the transporting roller being arranged in parallel, laterally next to the transporting rail and having an endlessly driven link chain with pins arranged in a row one behind another at a close distance on the link chain. The pins being arranged horizontally and extending over the transporting rail, preferably even beyond it. The row of pins having a plurality of gaps, which are provided at a preferably constant distance and into which the flanges of a transporting roller are in each case inserted and carried along between the pins.

### CROSS REFERENCE TO RELATED APPLICATION

This application claims priority to DE 10 2004 018 568.9, filed Apr. 16, 2004.

### FIELD OF THE INVENTION

The invention relates to a transporting apparatus having transporting rollers which each have two disk-shaped flanges, which are aligned parallel to one another, are spaced apart and are at a standstill during the transportation of the The apparatus further having a sleeve, which is set up for rolling on a rail, being arranged rotatably between the flanges, and the flanges and the sleeve being passed through centrally by a through passage into which a curved hook, for example a clothes hanger, can be fitted by the free end of the curved hook protruding out of the through passage.

### BACKGROUND OF THE INVENTION

A transporting roller of the general type of this invention and a transporting apparatus for it are described, for example, in EP 1 258 439 B1. The known transporting roller has proven successful in particular for transporting items of clothing hanging on clothes hangers, the roller running with its rotatable sleeve on a rail and the curved hook of a clothes hanger reaching through the curved hook of a clothes hanger reaching through the through passage. The through passage is selected to have a sufficiently large diameter for the curved hook to be able to be easily fitted in and removed.

The transportation of the roller with fitted curved hook of a clothes hanger, which is provided with an item of clothing, over planar sections with corresponding driving means does not give rise to any particular problems. For example, this can take place with driven pins which are arranged vertically and spaced apart in a comb-like manner, with the free curved-hook ends which protrude out of the transporting roller reaching into the gaps between the vertical pins and being carried along by the pins as described in EP 1 258 439 B1. By contrast, transportation on ascending or falling sections proves difficult because the resistance of the loaded transporting roller is considerably greater and the curved hooks can pivot in such a manner that they become disengaged. The same cannot be ruled out during transportation of rectilinear sections if the load of the item hanging on the hander is relatively heavy.

It is the object of the present invention to find a solution for the above-mentioned shortcomings of the prior art. This object is achieved by the features device described herein.

### BRIEF DESCRIPTION OF THE DRAWINGS

The invention is explained below and in more detail and by way of example with reference to the drawing, in which:

FIG. 1 shows a side view of an ascending transporting section with a transporting apparatus according to the invention;

FIG. 2 shows an end view of the transporting section from FIG. 1;

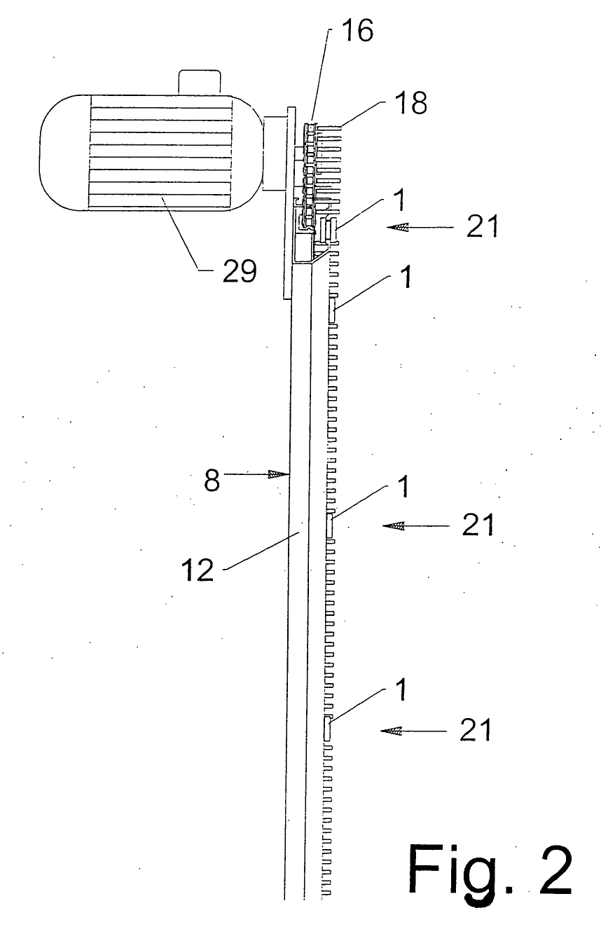

FIG. 3 shows a section through the ascending transporting section along the line A-A in FIG. 1 looking in the direction of the arrow;

FIG. 4 shows schematically a transporting roller, which can be transported by the transporting apparatus according to the invention, is known per se and has the curved hook of a hanger fitted in it.

### DETAILED DESCRIPTION OF THE INVENTION

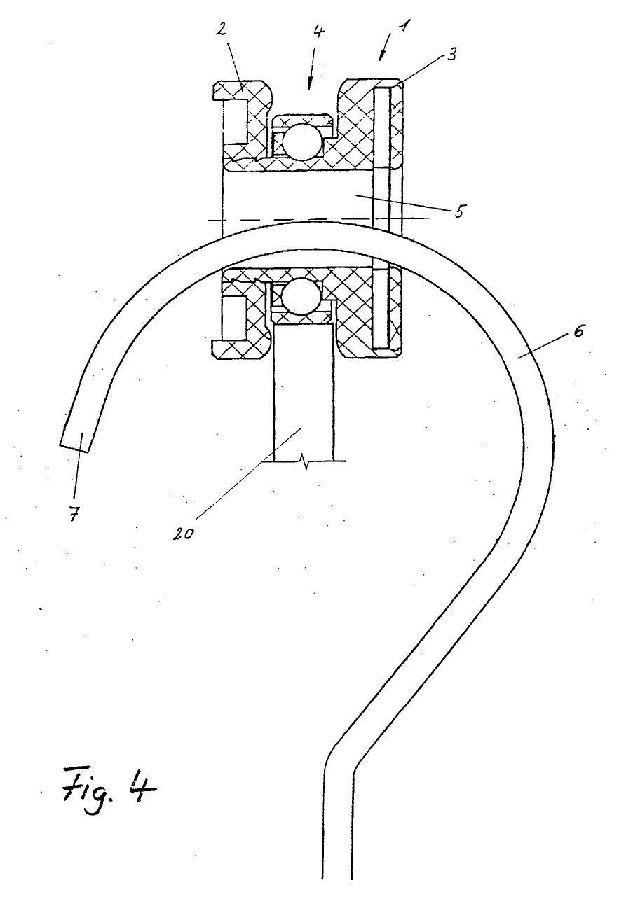

The transporting apparatus according to the invention is used to transport individual transporting rollers 1, as are disclosed, for example, in EP 1 258 439 B1, (see FIG. 9). Transporting rollers 1 of this type have two disk-shaped flanges 2, 3, which are arranged at a distance from each other, and a rotatably arranged sleeve 4 of smaller diameter in between as shown in FIG. 4. The sleeve 4 sits on a running rail of a transporting section and rotates during the transportation while the flanges 2, 3 do not rotate during such movement. The transporting roller 1 also has an axial or central through passage 5 through which a curved hook 6 of a hanger fitted in it reaches, the curved hook 6 being mounted on parts of the transporting roller that are at rest during the transportation, and its free hook end 7 protruding out of the through passage 5.

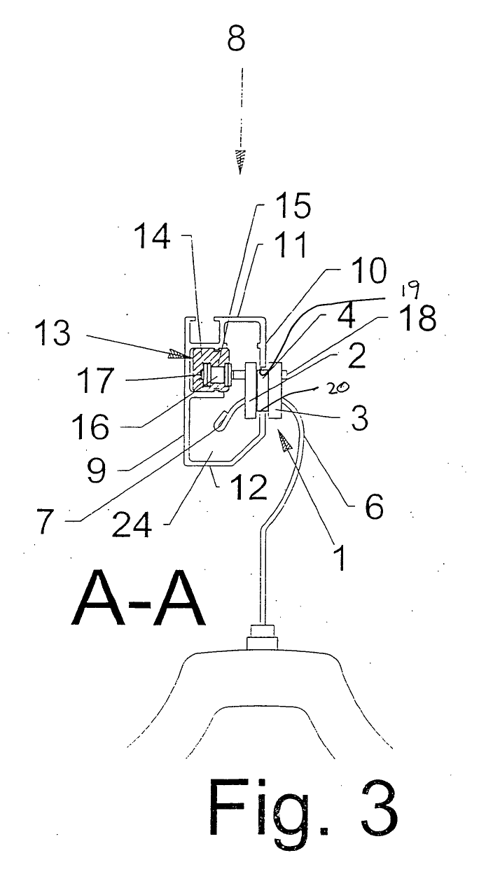

The transporting apparatus according to the invention has a positionally fixed, essentially rectangular hollow profile rail 8 with two vertical side walls 9, 10, a top wall 11 and a bottom wall 12 as shown in FIG. 3.

In the region between the transverse center of the one side wall 9 and the top wall 11 is formed a U-shaped chain passage 13, which is open in the direction of the other side wall 10 and the one wall of which is expediently formed by the side wall 9. Mounted in the chain passage 13 is a continuous plastic extruded section 14 into which a sliding passage 15 that is open in the direction of the other side wall 10 is placed. In the sliding passage 15 the lower strand 31 of a driven link chain 16 is guided in a manner such that it is form-fitting and secure against tilting, the upper stand 30 of which link chain runs in a vertical plane with the lower strand 31 outside and above the hollow profile rail 8 and the chain-link axes 17 of which are oriented horizontally. Pins 18 are arranged on the chain-link axes 17, in an extension thereof, preferably in a manner such that they can rotate about their longitudinal axis, and protrude out of the sliding passage 15 and the chain passage 13 into the hollow profile rail 8.

In the region of the transverse center, a continuous longitudinal slot 19 is placed into the other side wall 10 of the hollow profile 8, the distance between the longitudinal edges of the longitudinal slot 19 being somewhat larger than the diameter of the sleeve 4 and somewhat smaller than the diameter of the flanges 2, 3 of the transporting roller 1, the lower longitudinal edge forming a running rail 20 for the sleeve 4. in this case, the pins 18 of the link chain 16 are positioned in such a manner that they reach somewhat through the longitudinal slot 19.

According to the invention, the distance between two adjacent pins 18 is substantially smaller, for example by one fifth to one third smaller, than the diameter of the flanges 2, 3, with pins 18 being omitted at predetermined distances, forming larger gaps 21. The distance between the adjacent pins 18 in a gap 21 is smaller than the diameter of the flanges 2, 3, but is sufficiently large for the flanges 2, 3, to be able to be reached behind by a pin 18 of the gap and for the roller 1 to be able to be carried along by the pin. In this respect, a transporting roller 1 which is mounted on the running rail 20 can be pushed, if it sits in a gap 21, in the transporting direction 22 by that pin 18 of a gap 21 which is at the rear in the transporting direction 22, when the transporting chain 16 is driven.

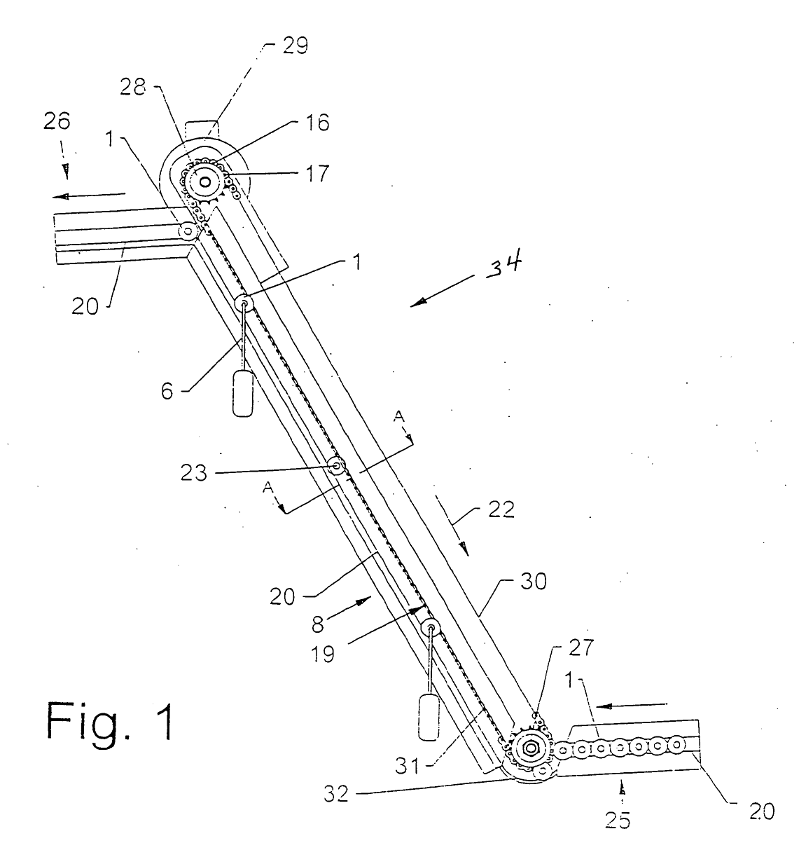

In the example illustrated, the gap 21 is somewhat narrower than the diameter of the flanges 2, 3, so that that pin 18 of the gap 21 which is at the rear in the transporting direction 23 of the transporting roller 1 and the circumferential surface of the flanges 2, 3, for example below one quarter of the radius of the flanges 2, 3, as shown in FIGS. 1 and 3.

A free through passage 24 is expediently provided within the profile rail 8 below the chain passage 13 for the free end 7 of the curved hook 6.

It lies within the scope of the invention, instead of a profile rail 8, which has both the chain passage 13 and the running rail 20, to use two separate elements.

According to one preferred embodiment of the invention, the transporting apparatus according to the invention is designed as an ascending section, as depicted.

An ascending section of this type has an ascending transporting section 34, a lower supply section 25, which is preferably inclined downward somewhat toward the transporting section 34, and an upper removal section 26, which is preferably inclined away downward somewhat from the transporting section 34. The sections 25 and 26 are expediently likewise profile rails with a running rail 20 for the transporting rollers 1.

One chain wheel 27 is arranged at the lower end of the transporting section 34 and one chain wheel 28 is arranged at the upper end, the upper chain wheel 28 being connected to the driving motor 29. The driving chain 16 with an upper strand 31 is endlessly guided over the chain wheels 27, 28, with the supply section 25 ending just before the upper strand 30 before the chain wheel 27 and the removal section 26 being positioned below the lower strand 31 just below the chain wheel 28, so that the routing of the section—as viewed from the side—has an approximately Z-shaped profile, as shown in FIG. 1.

A curved connecting web 32 extends from the running rail 20 of the supply section 25 to the running rail 20 of the transporting section 34, that end of the running rail 20 of the supply section 25 which is on the chain-wheel side being arranged approximately at the distance of the diameter of a transporting roller 1 from the pins 18 of the transporting chain 16. The running-off rail 20 of the removal section 26 is situated approximately at the same distance from the pins 18 of the lower strand 31 of the transporting chain 16.

Owing to the selected construction of the sections 34, 25, 26 and of the transporting gaps 21 between the pins 18, a transporting roller 1 resting at the supply end of the inclined supply section 25 is not carried along by the closely adjacent pins 18 of the transporting chain 16, which runs in the transporting direction 22, but rather is retained in its position. If a gap 21 emerges in the, for example, frontmost transporting roller 1 of a, for example, backed-up row of transporting rollers, as shown in FIG. 1, this transporting roller 1 falls into the gap 21 with respect to the pins 18, but cannot fall through it because the distance between the pins 18 of the gap 21 is at least somewhat smaller than the diameter of the flanges 2, 3. The transporting roller 1 is supported by the pins 18 of the gap 21 and carried along downward, with the transporting roller 1 preferably being supported on the rotating sleeve 4 by the connecting web 32. In the upwardly rising lower stand 31, the transporting roller 1 is pushed by the rear pin 18 of the gap 21 onto the running rail 20 of the transporting section 34 and carried along as far as the removal section 26. At the beginning of the removal section 26, the transporting roller 1 falls out of the gap 21 onto the running rail 20 of the removal section 26 and automatically continues to roll.

In the case of the transporting apparatus according to the invention, friction is minimal during the transportation. This is because the flanges 2, 3 of the transporting roller 1 are at a standstill as are the walls of the through passage 5, so that neither the pins 18 nor the curved hooks 6 can produce friction at the transporting roller 1.

It lies within the scope of the invention, instead of the closely adjacent pins 18, to use strips (not illustrated) which are arranged a distance from one another, forming the gap 21.

While the above description constitutes the preferred embodiment of the present invention, it will be appreciated that the invention is susceptible to modification, variation and change without departing from the proper scope and fair meaning to the accompanying claims.

1. A transporting apparatus comprising a fixed transporting rail and at least one transporting roller, which is supported by the transporting rail can be loaded with an item to be transported, the roller having an axial through passage and two disk-shaped, flanges, which are aligned parallel to each other and are not rotated during the transportation of the transporting roller and, between the flanges, a rotatably mounted rolling element of a smaller diameter than the diameter of the flanges which element rolls on the transporting rail during the transportation of the transporting roller, a carry-along device for the transporting roller being arranged in parallel laterally next to the transporting rail and having an endlessly driven link chain with a plurality of pins arranged in a row one behind another at a close distance on the link chain, wherein the pins are arranged horizontally and extend over the transporting rail and in that the row of pins has a plurality of gaps which are provided at a distance and into which the flanges of a transporting roller are inserted and carried along between the pins.

2. The transporting apparatus as claimed in claim 1, wherein the pins are arranged above the transporting rail in a plane which is situated between the axis of rotation of the rotating rolling element.

3. The transporting apparatus as claimed in claim 1, wherein the distance between the pins in a gap is smaller than the radius of the flanges.

4. The transporting apparatus as claimed in claim 3, wherein the distance between the pins in a gap is smaller than a quarter of the radius of the flanges and is larger than the thickness of the pins.

5. The transporting apparatus as claimed in claim 1, wherein the transporting rail is part of a positionally fixed, essentially rectangular hollow profile rail which has two vertical side walls, a top wall and a bottom wall, a continuous longitudinal slot being placed in one of the side walls, the distance between the longitudinal edges of the longitudinal slot being larger than the diameter of the rolling element and smaller than the diameter of the flanges, the lower longitudinal edge forming the transporting rail.

6. The transporting apparatus as claimed in claim 5, wherein a U-shaped chain passage that is open in the direction of one of the side walls is arranged in the region between the transverse center of the other of the side walls and the top wall, in which chain passage is mounted a continuous plastic extruded section into which a sliding passage that is open in the direction of the one side wall is formed.

7. The transporting apparatus as claimed in claim 6, wherein in the sliding passage a lower strand of the driven link chain is guided in a manner secure against tilting, the upper strand of the chain running in a vertical plane with a lower strand thereof outside and above the hollow profile rail and the chain-link axes of which link chain are oriented horizontally.

8. The transporting apparatus as claimed in claim 7, wherein the pins are arranged on the chain-link axes, in an extension thereof, preferably in a manner such that the pins can rotate about their longitudinal axis, and protrude out of the sliding passage and the chain passage into the hollow profile rail.

9. The transporting apparatus as claimed in claim 8, wherein the pins of the link chain are positioned in such a manner that they reach through the longitudinal slot.

10. The transporting apparatus as claimed in claim 1, wherein the distance between two adjacent of the pins is substantially smaller, and about one fifth to one third smaller, than the diameter of the flanges, with pins being omitted at predetermined distances, forming a plurality of larger gaps.

11. The transporting apparatus as claimed in claim 10, wherein the distance between the adjacent pins in the larger gaps is smaller than the diameter of the flanges, but is sufficiently large for the flanges to be able to be reached behind by one of the pins of the gap and for the transporting roller to be able to be carried along by the pin.

12. The transporting apparatus as claimed in claim 11, wherein the larger gap is narrower than the diameter of the flanges, so that that the pin of the larger gap which is at the rear in the transporting direction engages between the axis of rotation of the transporting roller and the circumferential surface of the flanges, is about below a quarter of the radius of the flanges.

13. The transporting apparatus as claimed in claim 1, wherein a free through passage, into which a free end of a curved hook reaching through the passage can protrude, is provided within the profile rail below the chain passage.

14. The transporting apparatus as claimed in claim 1, wherein the transporting apparatus is designed as an ascending section.

15. The transporting apparatus as claimed in claim 14, wherein the ascending section has an ascending transporting section, a lower supply section, which is inclined toward the transporting section, and an upper removal section, which is inclined away from the transporting section.

16. The transporting apparatus as claimed in claim 15, wherein the lower supply section and the upper removal sections are designed as hollow profile rails with a transporting rail for the transporting rollers.

17. The transporting apparatus as claimed in claim 15, wherein a first chain wheel is arranged at the lower end of the transporting section and a second chain wheel is arranged at the upper end, one of the chain wheels being connected to a driving motor, and the driving chain with the upper strand and the lower strand being endlessly guided over the chain wheels.

18. The transporting apparatus as claimed in claim 17, wherein the supply section ends just before the upper strand before the chain wheel and the removal section is positioned below the lower strand just below the chain wheel.

19. The transporting apparatus as claimed in claim 17, wherein a curved connecting web extends from the transporting rail of the supply section to the transporting rail of the transporting section, that end of the transporting rail of the supply section which is on the chain-wheel side being arranged approximately at the distance of the diameter of a transporting roller from the pins of the transporting chain.

20. The transporting apparatus as claimed in claim 17, wherein the transporting rail of the removal section is situated approximately at the same distance from the pins of the lower strand of the transporting chain as the transporting rail of the supply section.

21. The transporting apparatus as claimed in claim 19, wherein the transporting roller is supported on the rotating rolling element by the connecting web.
